(19) United States
(12) Patent Application Publication
(10) Pub. No.: US 2008/0093271 A1
(43) Pub. Date: Apr. 24, 2008

(54) APPARATUS FOR SEPARATING SOLIDS FROM A LIQUID

(75) Inventors: Peter Carlo Rem, Rijswijk (NL); Simon Peter Maria Berkhout, Schipluiden (NL)

Correspondence Address: PEACOCK MYERS, P.C., 201 THIRD STREET, N.W., SUITE 1340, ALBUQUERQUE, NM, 87102, US

(73) Assignees: Technische Universiteit Delft, Delft (NL); Gemeente Amsterdam, Afval Energie Bedrijf, Amsterdam (NL)

(21) Appl. No.: 11/937,982

(22) Filed: Nov. 9, 2007

Related U.S. Application Data
(63) Continuation-in-part of application No. PCT/NL2006/050112, filed on May 10, 2006.

(30) Foreign Application Priority Data
May 12, 2005 (NL) NL 1029022

(51) Int. Cl. B03B 5/22; B03B 11/00; B03B 5/24

(52) U.S. Cl. 209/494

(57) ABSTRACT

An apparatus and a method for separating a material stream consisting of several materials. The materials to be separated have different densities or density ranges, so that the material of the highest density can be discharged through a screen of the apparatus, while the material of the lowest density can be discharged via a first outlet located near the top of the liquid. Material of an intermediate density is discharged via a second outlet, located at a position above and near the screen. An extra liquid supply, directed in counter flow to the flow of the material stream to be separated, ensures the effective removal of material of the lowest density.

### CROSS-REFERENCE TO RELATED APPLICATIONS

This application is a continuation-in-part application of International Patent Cooperation Treaty Application Serial No. PCT/NL2006/050112, entitled “Apparatus for Separating Solids form a Liquid”, to Peter C. Rem and Simon P. M. Berkhout, filed on May 10, 2006, and the specification and claims thereof are incorporated herein by reference.

This application claims priority to and the benefit of the filing of Netherlands Patent Application Serial No. NL 1029022, entitled “Apparatus for Separating Solids form a Liquid”, filed on May 12, 2005, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to an apparatus for separating solid materials from a liquid, comprising:

a screen through which a pulsed flow of hutchliquid is passed upward;

a ragging layer on the screen with ragging particles whose diameter is larger than the openings in the screen;

an inlet for a material stream to be separated, wherein the material stream to be separated comprises at least two different materials of different densities,

wherein at least a part of the material stream to be separated is conveyed upward via the screen from the inlet to a position located at a distance therefrom and is brought into a fluidized condition by the hutch flow; and

a first outlet for at least one of the materials at the upper side of the screen, wherein the first outlet is located between the inlet and the said position located at a distance therefrom

2. Description of Related Art

Such an apparatus is widely used in the art and is known as a jig. This involves a pulsed flow of hutch water being passed through the screen, so that the pulsed hutch flow pushes both the ragging particles and the material stream to be separated upward. The fall velocity with which these materials subsequently fall back onto the screen when the hutch flow is temporarily stopped depends on, among other things, the specific density, shape and size of those materials. A person skilled in the art is quite capable of supplying the pulsed hutch flow in such a manner that the materials of the highest density are discharged down through the ragging particles and the screen, while the materials of a less high density remain between or on the ragging particles, or even become suspended in a supernatant liquid. Such a technique is general knowledge to a person skilled in the art and is described in SME Mineral Processing Handbook, N. L. Weiss (ed.) New York (1985), pp. 4-31.

Although the invention is not limited to a material stream of a specific composition, the material stream mainly referred to hereinafter comprises a mixture of heavy metals, sand and organic matter. These three materials have, in that order, decreasing specific densities and are therefore referred to as “material of highest density”, “material of less high density” and “material of lowest density”, respectively. In each case, the materials to be separated are solids.

In the art, jigs of many different types are used. In general, the material stream to be separated is applied on the ragging layer and the screen at a first position, and subsequently conveyed to a position at a distance therefrom. During this conveyance, pulsed hutch water is being passed, so that eventually the materials of the highest density are discharged through the ragging layer, and the screen, while the materials of a less high density remain between the ragging particles or above these, for example, fluidized or suspended in the liquid. The liquid is then possibly already present, in which case the material stream, to be separated is supplied as dry matter; or the material stream may be supplied as suspension. The invention is not limited to any particular manner of supply.

The drawback of the known methods is that all the material not falling through the ragging particles and the screen has to be discharged as a single stream via the outlet opening of the apparatus. So far there is no suitable possibility for a further separation which, in addition to the above-mentioned system of heavy metals, sand and organic material, would also allow the sand to be discharged separate from the organic material.

### BRIEF SUMMARY OF THE INVENTION

The general object of the invention is to provide an improved apparatus for the separation of solids from a liquid.

### DETAILED DESCRIPTION OF THE INVENTION

The object of the invention is in particular to provide an apparatus with which at least three solids of different densities can be separated individually from a liquid.

The object of the invention is also to provide an improved method for separating a material stream comprising at least two different materials of different densities.

The object of the invention is in particular to provide a method by which at least three different materials of different densities can be separated from a material stream.

When in this description the term “materials of different densities” or the like is used, this must be understood to refer to a mixture of materials of different densities. There is no limitation to a maximum of two different densities. In those cases it is according to the invention possible to perform a separation on, for example, two density ranges (“material stream comprising at least two different materials” etc.) or three density ranges (“material stream comprising at least three different materials” etc.).

In order to achieve at least one of the above mentioned objectives, the invention provides an apparatus as mentioned in the preamble, wherein the apparatus further comprises an outlet for the discharge of another of the materials, selected from at least one of:

a second outlet positioned near the location at a distance from the inlet, and

the screen.

In this way at least the material of the lowest density can always be discharged at a position above the ragging layer. It goes without saying that this first outlet is located in the liquid and above the ragging layer, such that substantially no material of a higher density than the desired lowest density is discharged via this first outlet.

According to the further preferred embodiment, an inlet for liquid is provided at a position between the first outlet and said position located at a distance from the inlet for the material stream. This produces a substantially counter-oriented flow through said liquid, directed over the upper side of the material stream to be separated and conveyed over the screen. As a result, said liquid will entrain mainly the material of the lowest density from said material stream and discharge it via the first outlet. The upper layer of this material stream will consist mainly of only the materials of the less high density without the ragging particles.

According to the preferred embodiment, a second outlet is provided near the position located at a distance from the inlet for at least one of the materials. When separating on two density ranges (or two densities), this second outlet is preferably provided for the material of the highest density, but this second outlet may also be provided for material of the less high density that is not discharged via the screen when separating three density ranges (or three densities) .

It is especially preferable to combine all or some of the various measures described in the above description.

When separating on three density ranges (or three densities) in the aforementioned embodiments, the screen serves as third outlet for material of the highest specific density.

The apparatus according to the invention is especially very suitable for separating a material stream of at least three different materials, and comprises a screen for the discharge therethrough of material of a highest density, a second outlet for discharging material of a less high density, and a first outlet for the discharge of material of a lowest density. Especially the above-described apparatus according to the invention provides a very suitable separation of these three materials when using this method. A person skilled in jigging techniques will be capable of operating this apparatus such that a suitable separation is obtained.

It is further preferred for the inlet of liquid to be directed at the upper side of the material stream passing over the screen. This will cause material of a lowest density present in the upper layer of the material stream passing over the screen, possibly in combination with the material of less high density to be loosened by this supply of liquid, causing said material to become suspended and subsequently to be discharged via the first outlet of the apparatus.

The combination of this extra supply of liquid and the hutch liquid supplied via the screen ensures continuous discharge of liquid and material of low density via the first outlet.

The second outlet is preferably formed by a closing- off means carried by the fluidized material stream. This closing-off means may, for example, have a density such that when the solid material on the ragging layer (the layer fluidized by the hutch water) is at a desired or lower level, it seals a second outlet in the apparatus, whereas when the fluidized layer is at a higher level than the desired level, it is forced upward, thereby opening the second outlet. This will primarily allow the material that is to be discharged via the second outlet to be discharged from the apparatus.

If the level of the fluidized layer in the apparatus rises, the closing-off means may begin to float in or even on top of the liquid.

It is especially preferred for the closing-off means to have a cylindrical body, rotatably disposed around a longitudinal axis and in its extended direction in contact with the material to be discharged via the second outlet. This body may be kept in rotation in a manner such that at least a portion of the fluidized layer discharges from the apparatus. For example, the body may be kept in continuous rotation if a fluidized layer of material is present on the ragging layer near the body. The amount of material to be discharged can be controlled by varying the speed of rotation. Also, a thicker layer of fluidized material will generate a faster discharge of material via this second outlet, as in that case the body is raised to a higher position, creating a larger outlet opening at its lower side.

According to a further preferred embodiment, the position of the first outlet in the apparatus is substantially fixed, so that the level of the liquid in the apparatus stays substantially the same. Thus the position of the first outlet determines the depth of the liquid in the apparatus. In principle, the first outlet may also be floating in the liquid. If desired, a minimum height above the material stream passing over the screen may be maintained. In general it will be preferred for the first outlet to have a fixed position.

As mentioned before, the invention also relates to a method for the separation of a material stream, wherein the material stream comprises at least two different materials of different densities, which method comprises the following steps:

supplying the material stream to the inlet of an apparatus according to claim 1,

passing a pulsed flow of liquid upward through the screen in order to fluidize the material stream to be separated,

discharging material of a relatively higher density via a second outlet located at a distance from the solid matter inlet, and

discharging material of a relatively lower density via the first outlet.

Such a method is very suitable to be applied with the apparatus according to the invention.

According to a particular preferred embodiment, the invention relates to such a method, wherein a material stream comprising three different materials is supplied to the apparatus according to the invention comprising three outlets. In this case, the material of the highest density is discharged via the screen {the third outlet), the material of a less high density is discharged via the second outlet and the material of a lowest density is discharged via the first outlet.

It will generally be preferred for the discharge of the largest fraction to be discharged to take place via the second outlet. Discharge via the first or third outlet would cost too much screen space, or the first outlet would take up too much space.

The methods according to the invention may be applied using any of the different features of the apparatus according to the invention. The method in particular also comprises the supply of a liquid stream from a position which, viewed from the inlet for the material stream to be separated, is located at a distance from the first outlet and directed at the upper side of the material stream to be separated passing over the screen. In this way the advantages may be achieved as discussed above with respect to the apparatus.

With the method and the apparatus according to the invention it is especially preferred for discharge of the material of the less high density to take place via the second outlet because the second outlet is raised in order to discharge from thereunder the material of a less high density from the apparatus.

Such an adjustment in height may occur automatically, for example, a rise of the level of the fluidized bed of material forces the closing-off means upward, but another possibility within the frame of the invention is to open and/or close the second outlet as deliberately.

### DESCRIPTION OF THE SEVERAL VIEWS OF THE DRAWINGS

The invention will be further described by way of a drawing and a preferred embodiment.

FIG. 1 shows a schematic illustration of an apparatus according to the invention.

FIG. 2 shows a preferred embodiment of the apparatus according to FIG. 1.

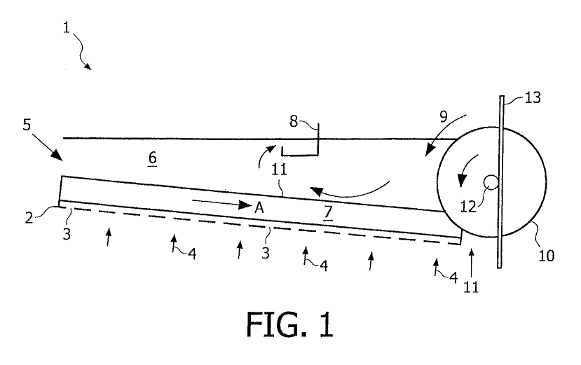

FIG. 1 shows a schematic view of the apparatus according to the invention. This apparatus 1 comprises a screen layer 2 wherein openings 3 are provided. Through these openings 3, hutch water 4 (schematically indicated with arrows) is passed upward. This supply of hutch water 4 may be a pulsed flow.

A material stream 5 to be separated is supplied from above onto the screen 2. As shown in the figure, this material stream 5 to be separated is supplied to the apparatus at one end and subsequently carried over the screen in the direction of arrow A.

In accordance with common practice, a ragging layer may be provided on the screen 2. The diameter of the particles of the ragging layer is larger than the openings 3 in the screen 2. The material stream to be separated is introduced into a liquid 6. The material stream 5 to be separated may be supplied to the liquid 6 either as solid or as suspension in a liquid.

Due to the pulsed supply of hutch water 4 and the sloping screen 2, the material stream to be separated will be carried over the screen 2 in the direction of arrow A. The substances of the highest density will be discharged downward through the ragging layer and the openings 3 of the screen 2. The substances of less high density will remain in and/or on the ragging layer, while substances of the lowest density will become suspended in the liquid 6 and/or will remain on top of the layer 7.

For the discharge of substances of the lowest density a first outlet 8 is provided. Via the outlet 8, liquid and material suspended in the liquid are discharged. As shown in the figure, said first outlet 8 is located between the position where the material stream 5 to be separated is supplied and the position furthest away therefrom. The first outlet 8 is located near the upper side of the liquid 6.

In order to also ensure that the material of the lowest density on top of the layer 7 is suitably removed, an extra supply of liquid 9 is provided. This extra supply of liquid 9 is introduced into the liquid 6 near a closing-off means 10. This extra liquid is directed over the top side 7′ of the layer 7, causing material thereon to be forced into the liquid. As a result, it will be possible to conveniently discharge this material as well via the first outlet 8.

This manner provides a suitable separation of material of a highest density via the openings of the screen 3 and of material of a lowest density via the first outlet 8.

The material of a less high density will be deposited on the ragging particles substantially in the form of a fluidized layer.

A suitable manner for removing this material of a less high density is the provision of an outlet 11. Via the outlet 11, the material of a less high density can be discharged quite simply from the apparatus 1. The outlet 11 can be closed off with a closing-off means 10. In the embodiment illustrated, the closing-off means 10 is a cylindrical construction rotatable about an axis 12. A lateral movement (in the figure to the right) of the closing-off means 10 is prevented by a guiding device 13. A displacement of the closing-off means 10 to the left is prevented by the liquid 6. The specific weight of the cylinder 10 may be chosen such that when the level of the liquid 6 and/or the level of the fluidized layer are at a desired position or lower, the same is positioned on and/or in the layer 7 such that this closing-off means closes off the second outlet 11. When the level of the liquid 6 and/or the level of the fluidized layer rises, the closing-off means 10 may be adjusted such that it will float or is forced upward. As shown in the figure, the closing-off means 10 can readily be displaced in the vertical plane. In its lowest position the closing-off means 10 will be positioned on and/or in the layer 7. This makes discharge of liquid and solids via the second outlet 11 substantially impossible.

It is finally observed that when the first outlet 8 is mounted at a fixed position, the height of the outlet for the liquid 6 is preferably located at a position just below the top edge of the closing-off means 10.

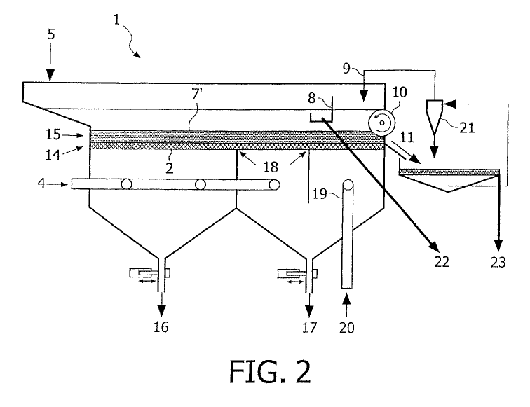

According to the preferred embodiment of FIG. 2, the material stream 5 to be separated is supplied onto the screen 2 on which a ragging layer 14 is provided. This forms the jig bed 15 on the ragging layer. Under the screen 2, there are two outlets 16 and 17, respectively, via which the material of the highest density is discharged.

Hutch water 4 is supplied from below the screen 2. This may be process water. Optionally fresh water 20 may be supplied via the inlet 19 as hutch water, so that in fact the material of the less high density on the screen 2 is washed before being discharged via the second outlet 11. Under the screen 2 seals 18 are provided, which prevent a lateral displacement of the hutch water as well as a lateral displacement of the material of the highest density passed through the screen 2.

The material discharged via the outlet 11 consists of material of a less high density and water. The water may be substantially purified in a cyclone 21 or the like and used as extra supply of liquid 9.

The material 22 with the lowest density is discharged via the first outlet 8. The material 23 with the less high density is discharged via the second outlet 11.

### Exemplary Embodiment

A mixture of solids to be separated originating from a domestic waste incineration plant and consisting substantially of sand is supplied into the apparatus according to FIG. 2. This mixture of solids consists of organic substances (i.e. the lowest specific weight fraction), sand (i.e. the medium specific weight fraction) and (heavy) metals (i.e. the highest specific weight fraction). By its rotation, the cylindrical body ensures that sand is discharged from the apparatus. The organic substances were discharged via the first outlet, and the fraction of the highest specific weight was discharged through the screen.

The characteristics of the apparatus and method in the exemplary embodiment are as follows:

TABLE 1
Operational Parameters

| Parameter | Value | Unit |
|---|---|---|
| Surface area screen (l × w) | 2X 0.7 | m² |
| Water over cylinder | 3 | m³/hour |
| Hutch water | 14 | m³/hour |
| Stroke length | 9.5 | mm |
| Stroke frequency | 2 | Hz |
| Screen opening | 3 | mm |
| Ragging (gravel) | 4-6 | mm |
| Solids content supply | 45 | mass % |
| Grain size supply | 0-2 | mm |
| Throughput | 12 | ton dry |
| | | matter/hour |

A total of 5000 kg sand originating from bottom ash was processed in an apparatus according to the invention. The cylindrical body (diameter approximately 0.15 m, width 0.7 m) ensured regular discharge of sand from the apparatus and was driven at a rotational speed of approximately 0.5 revolutions per second.

The organic matter content of the substance mixture to be separated was 0.5-0.8% by weight. The organic matter content of the resulting sand fraction obtained was 0-0.15% by weight.

In Table 2 below, the amount of (heavy) metals in the supplied substance mixture is compared with that in the discharged sand fraction. Table 3 shows results from leaching measurements for the supplied substance mixture and for the obtained sand fraction.

The composition of the substance mixture to be separated and the sand fraction obtained were analyzed in identical ways.

TABLE 2
Composition of the product sand compared with supply

| | Supply (mg/kg) | Product sand |
|---|---|---|
| Organic | 5000-8000 | 0-1500 |
| Lead | 3700 | 750 |
| Cadmium | 13 | 0 |
| Copper | 4600 | 1150 |

TABLE 3
Immission values (based on NEN (Dutch Standard) 7343
column test: mg/m² at application level of 0.2 m) of
bottom ash supply versus sample of the sand product

| | Supply | Product Sample | N1 |
|---|---|---|---|
| Cl | 394 000 | 14 400 | 87 000 |
| SO₄ | 367 000 | 110 000 | 300 000 |
| Sb | 37 | 98 | 117 |
| Cu | 1 700 | 352 | 540 |
| Mo | 240 | 77 | 450 |

This demonstrates that the apparatus according to the invention provides a very convenient, simple and inexpensive manner for separating a feed mixture into different product streams of different specific weights. Thus all the objectives of the invention are fulfilled.

The invention is described by way of a preferred embodiment, illustrated in the figure. The invention is not limited thereto.

A person skilled in the art is quite capable of modifying the apparatus and the method. However, any modifications fall within the protective scope of the appended claims.

What is claimed is:

1. An apparatus for separating solid materials from a liquid, comprising:
a screen through which a pulsed flow of hutchliquid is passed upward;
a ragging layer on the screen with ragging particles whose diameter is larger than the openings in the screen;
an inlet for a material stream to be separated, wherein the material stream to be separated comprises at least two different materials of different densities,
wherein at least a part of the material stream to be separated is conveyed upward via the screen from the inlet to a position located at a distance therefrom and is brought into a fluidized condition by the hutch flow and
a first outlet for at least one of the materials at the upper side of the screen, wherein the first outlet is located between the inlet and the said position located at a distance therefrom;
wherein the apparatus further comprises an outlet for the discharge of another of the materials, selected from at least one of:
a second outlet positioned near the location at a distance from the inlet, and
the screen.

2. An apparatus according to claim 1, wherein an inlet for liquid is provided between the first outlet and the said position located at a distance from the inlet.

3. An apparatus according to claim 1, for separating a material stream comprising at least three different materials, wherein a screen serves as third outlet for discharging material of the highest specific density, a second outlet for discharging material of a less high density, and a first outlet for discharging material of a lowest density.

4. An apparatus according to claim 1, wherein the supply of liquid is directed at the upper side of the layer conveyed over the screen.

5. An apparatus according to claim 3, wherein the second outlet comprises a closing-off means carried in the liquid.

6. An apparatus according to claim 5, wherein the closing-off means has a cylindrical body, rotatably disposed around a longitudinal axis and in its extended direction in contact with the material to be discharged via the second outlet.

7. An apparatus according to claim 5, wherein when the fluidized layer is at a desired or lower level, the closing-off means seals the second outlet and at a higher level opens the second outlet.

8. An apparatus according to claim 7, wherein when the fluidized layer is at a higher level, the closing-off means floats in or on top of the liquid.

9. A method for separating a material stream comprising, at least two different materials of different densities/ comprising the supply of the material stream to the inlet of an apparatus according to claim 1, passing a pulsed flow of liquid upward through the screen in order to fluidize the material stream to be separated, discharging material of a relatively higher density via a second outlet located at a distance from the solid matter inlet, and discharging material of a relatively lower density via the first outlet.

10. A method according to claim 9, involving the supply of a material stream comprising three different materials to the inlet of the apparatus, wherein material of a highest density is discharged via a screen, material of a less high density is discharged via a second outlet, and material of a lowest density is discharged via a first outlet.

11. A method according to claim 9, involving the supply of a liquid stream from a position which, viewed from the inlet for the material stream to be separated, is located behind the first outlet and directed at the upper side of the material stream to be separated passing over the screen.

12. A method according to claims 9, involving the discharge of the material of the less high density via the second outlet, wherein the second outlet is raised in order to discharge the material of a less high density from thereunder.
